(19) United States
(12) Patent Application Publication
(10) Pub. No.: US 2021/0218092 A1
(43) Pub. Date: Jul. 15, 2021

(54) HIGH POWER AND HIGH ENERGY SELF-SWITCHING ELECTROCHEMICAL STORAGE DEVICE

(71) Applicant: POLITECNICO DI TORINO, Torino (IT)

(72) Inventors: Silvia BODOARDO, Torino (IT); Usman ZUBAIR, Torino (IT); Mara SERRAPEDE, Torino (IT); Julia Ginette Nicole AMICI, Torino (IT); Pietro ZACCAGNINI, Torino (IT); Daniele VERSACI, Torino (IT); Carlotta FRANCIA, Torino (IT); Candido Fabrizio PIRRI, Torino (IT); Andrea LAMBERTI, Torino (IT)

(73) Assignee: POLITECNICO DI TORINO, Torino (IT)

(21) Appl. No.: 17/059,279

(22) PCT Filed: Apr. 30, 2019
(86) PCT No.: PCT/IB2019/053525

§ 371 Date: Nov. 27, 2020

(30) Foreign Application Priority Data
Jun. 1, 2018 (IT) 102018000005943

(51) Int. Cl. H01M 16/00; H01M 10/0525; H01M 10/054; H01M 4/38; H01M 4/42; H01M 10/0565; H01G 11/08; H01G 11/38; H01G 11/36; H01G 11/30; H01G 11/62; H01G 11/56

(52) U.S. Cl. CPC H01M 16/00; H01G 11/26; H01M 10/054; H01M 4/382; H01M 4/42; H01M 10/0565; H01G 11/08; H01G 11/38; H01G 11/36; H01G 11/30; H01G 11/62; H01G 11/56; H01M 2220/20; H01M 2300/0082; H01M 2300/0068; H01M 10/0525

(57) ABSTRACT

An electrochemical device includes an electrochemical cell, wherein the electrochemical cell including a first anode and a first electrolyte, and a supercapacitor, wherein the supercapacitor including a second anode and a second electrolyte. The electrochemical cell and the supercapacitor are arranged in series and a single cathode shared both by the electrochemical cell and by the supercapacitor, while the first anode and the second anode are connected directly to each other; the single cathode comprises a porous matrix, wherein an active substance belonging to the group of Chalcogens, or group 16, of the Periodic Table of the Elements is infused inside the porous matrix. The electrochemical device is configured to accumulate and deliver simultaneously high levels of both an energy higher than 500 Wh/kg and a power higher than 1,000 W/kg) making a current flow independently into the electrochemical cell or into the supercapacitor depending on energy needs.

### CROSS REFERENCE TO THE RELATED APPLICATIONS

This application is the national stage entry of International Application No. PCT/IB2019/053525, filed on Apr. 30, 2019, which is based upon and claims priority to Italian Patent Application No. 102018000005943, filed on Jun. 1, 2018, the entire contents of which are incorporated herein by reference.

### TECHNICAL FIELD

The present invention relates to the energy sector and, in particular, to advanced energy and power storage and supply systems.

Specifically, the present invention relates to hybrid devices capable of self-managing high energy and high power conditions.

The preferred fields of application of the present invention are those in which electrical power supply is used, such as the automotive field (e.g. electric and hybrid vehicles), that of renewable energies as well as power and consumer electronics, and the like.

### BACKGROUND

Traditional energy storage technologies are substantially subdivided between systems capable of accumulating and delivering large amounts of low-power energy and systems capable of accumulating and delivering large amounts of power.

Currently, the development is focusing on the so-called “Post Lithium-Ion” storage technologies. Among these, there are systems capable of accumulating and delivering large quantities of low-power energy, such as Lithium-Sulphur batteries.

Examples of these Lithium-Sulphur batteries are described in patent documents U.S. Pat. No. 7,250,233 B2, U.S. Pat. No. 8,188,716 B2 and U.S. Pat. No. 9,768,466 B2.

These Lithium-Sulphur batteries show disadvantages due to the migration and solubility of polysulphides; actually, it has been demonstrated that, in Lithium-Sulphur batteries, the Sulphur moves towards the cathode surface during the charge and discharge cycles, thus reducing the amount of elemental sulphur present inside the cathode itself. During the discharge, the sulphur—reducing—forms soluble anionic species, called polysulphides. Finally, it precipitates on the electrode surface as lithium sulphide. These solubilization and re-precipitation processes cause the active matter to move towards the surface.

“Post Lithium-Ion” technologies allow to accumulate high energy densities, but at low power; to overcome this limitation, two types of solutions are currently being studied.

The first type consists in the coupling of an energy battery with a power battery, or with a supercapacitor; this solution, mainly adopted by automotive companies, provides for the coupling being carried out using external electronic systems connecting the two storage systems.

Examples of this first type are described in patent documents US 2009/0273236 A1 and US 2010/0001581 A1.

This first type of solution results rather complicated, heavy and cumbersome; moreover, the system is not autonomous in the sense that the high energy or high power management are regulated externally by the electronic control system.

The second type consists of a hybrid system, also called “supercabattery” or “supercapattery”, in which an attempt to connect the energy battery and the supercapacitor is made.

Examples of this second type are described in patent documents US 2016/0365613 A1, US 2017/0149107 A1 and US 2017/0323735 A1.

This second type of solution does not reach energy densities comparable to those of the Lithium-Sulphur cells, whose theoretical energy density is at least five times higher than that of this second type of solution.

A system capable of accumulating and delivering simultaneously high levels of energy and power would satisfy the needs of numerous applications such as, for example, electric vehicles, for which high energy is required to travel a high number of kilometres as well as high power for acceleration and energy recovery during braking, and the renewable energy storage systems, for which the regulation of power peaks without wasting energy is required.

The present invention, which is part of the hybrid systems field (the second type of solutions described above), intends to meet the aforementioned requirement.

In particular, the present invention is directed to solve the technical problem of how to realize the direct connection of a high energy battery with a high power supercapacitor.

Moreover, the present invention is directed to solve the technical problem of how to accumulate and deliver a high energy and high power simultaneously in a single device.

In summary, therefore, up to the present time, to the knowledge of the Applicant, there aren't any three-electrodes known solutions which allow to accumulate and supply high energy and high power simultaneously.

Therefore, with the device according to the present invention, the Applicant intends to remedy this lack.

### SUMMARY

The object of the present invention is to overcome the drawbacks of the known art associated with the impossibility of accumulating and delivering simultaneously high energy and high power.

More specifically, the object of the present invention is to overcome the drawbacks of the hybrid systems.

In particular, the present invention is directed to solve the problem of how to realize the direct connection of a high energy battery with a high power supercapacitor.

These objectives are achieved with the device according to the present invention which, advantageously and thanks to the presence of a single cathode shared by an electrochemical cell and a supercapacitor directly connected to each other and between which the current flows according to the energy needs, allows the self-management of simultaneous high energy and high power conditions.

The device according to the present invention combines for the first time in a single system, to the knowledge of the Applicant, the ability both to accumulate and produce high energy and to accumulate and produce high power by exploiting the disadvantages of the Lithium-Sulphur batteries of the known technique.

As aforesaid, in the Lithium-Sulphur batteries, the solubility of polysulphides and their migration towards the surface of the cathode and in solution occurs: in the device according to the present invention, the migration and solubility of polysulphides towards the surface of the single shared cathode causes this cathode to have two faces, a sulphur-rich one in towards the metal anode of the electrochemical cell and a sulphur-free one towards the carbon anode of the supercapacitor; in this way, the electrochemical cell and the supercapacitor of the device according to the present invention use a single double-faced cathode and two different anodes.

The foregoing does not work with traditional Lithium-ion batteries, since the reactions occurring in the electrochemical cell must be separated from what occurs into the supercapacitor; actually, in the device according to the present invention, during the discharge of the battery, the reaction products (i.e., polysulphides) move towards the Lithium anode so that the electrochemical cell and supercapacitor result separated, but operate in a cooperative manner.

The fact that the Sulphur can move towards the surface causes a surface of the electrode (the one facing the Lithium-Sulphur cell) to be rich in Sulphur, while the other surface of the electrode (the one facing the supercapacitor) is substantially consisting of carbon; the term “Sulphur-rich” means that the surface of the electrode facing the Lithium-Sulphur cell has a Sulphur content of at least 5% higher than the Sulphur content of the electrode surface facing the supercapacitor.

Therefore, during cycling, two directly coupled devices are made; this causes the electrochemical reactions to take place in a region separate from that of the supercapacitor, allowing both systems—Lithium-Sulphur battery and supercapacitor—to operate simultaneously.

Specifically, the above and other objects and advantages of the invention, as will appear from the following description, are achieved with an electrochemical device according to claim 1.

Preferred embodiments and variants of the electrochemical device according to the present invention form the subject matter of the dependent claims 2 to 8.

Another aspect of the present invention relates to an electric vehicle comprising at least one electrochemical device according to the present invention and constitutes the object of claim 9.

Another aspect of the present invention relates to a renewable energy storage system comprising at least one electrochemical device according to the present invention and constitutes the object of claim 10.

It is understood that all the appended claims form an integral part of the present description and that each of the technical characteristics claimed therein is possibly independent and can be used autonomously with respect to the other aspects of the invention.

It will be immediately apparent that countless modifications could be made to what described (for example related to shape, sizes, arrangements and parts with equivalent functionalities) without departing from the scope of protection of the invention as claimed in the appended claims.

Advantageously, the technical solution according to the present invention, which provides an electrochemical device with automatic switching for high energy and high power storage, allows to:
obtain an energy density of at least 500 Wh/kg;
obtain a power density of at least 10,000 W/kg;
ensure at least 2,000 cycles;
have a very low cost of around 100 €/kWh;
have a high versatility of design and use, according to specific needs;
allow fast recharging of electric vehicles, in case of such application.

Further advantageous characteristics will become more apparent from the following description of preferred, but not exclusive, embodiments, provided purely by way of example and not of limitation.

### BRIEF DESCRIPTION OF THE DRAWINGS

The present invention will be described hereinafter by way of some preferred embodiments, provided by way of example and not of limitation, with reference to the accompanying drawings. These drawings illustrate different aspects and examples of the present invention and, where appropriate, similar structures, components, materials and/or elements in different figures are denoted by similar reference numerals.

FIG. 1 is a schematic perspective representation of the preferred embodiment of the electrochemical device according to the present invention;

FIG. 2 is a frontal section of FIG. 1,

FIG. 3 is a schematic perspective representation illustrating a first operating step, under high current conditions, of the electrochemical device of FIG. 1;

FIG. 4 is a schematic perspective representation illustrating a second operating step, under low current conditions, of the electrochemical device of FIG. 1;

FIG. 5 is a reaction diagram of Sulphur in a traditional Lithium-Sulphur electrochemical cell;

FIG. 6 is an operating diagram of a traditional Lithium-Sulphur electrochemical cell;

FIG. 7A is an SEM (Scanning Electron Microscope) image showing the porous matrix of the single cathode of the electrochemical device of FIG. 1;

FIG. 7B is an SEM (Scanning Electron Microscope) image showing the Sulphur infusion in the porous matrix of the single cathode of the electrochemical device of FIG. 1;

FIG. 8 is a bar graph showing the performance of the electrochemical device according to the present invention compared with the performance of known solutions;

FIG. 9 is a schematic perspective representation of a first alternative embodiment of the electrochemical device according to the present invention;

FIG. 10 is a schematic perspective representation of a second alternative embodiment of the electrochemical device according to the present invention;

FIG. 11 is a schematic perspective representation of a third alternative embodiment of the electrochemical device according to the present invention;

FIG. 12 is a constant current discharge and charge curve which illustrates Example 1 of the present invention;

FIG. 13 is a constant current discharge and charge curve which illustrates Example 2 of the present invention; and

FIG. 14 is a constant current discharge and charge curve which illustrates Example 3 of the present invention.

### DETAILED DESCRIPTION OF THE EMBODIMENTS

While the invention is susceptible to various modifications and alternative constructions, some preferred embodiments are shown in the drawings and will be described in detail hereinbelow. It should be understood, however, that there is no intention to limit the invention to the specific embodiments illustrated, but, on the contrary, the invention is intended to cover all modifications, alternative constructions, and equivalents which fall within the scope of the invention as defined in the claims.

In the following description, therefore, the use of “for example”, “etc.”, “or”, “either” indicates not exclusive alternatives without any limitation, unless otherwise indicated, the use of “also” means “including, but not limited to” unless otherwise indicated; the use of “includes/comprises” means “includes/comprises but not limited to” unless otherwise indicated.

The device of the present invention is based on the innovative concept of combining an electrochemical cell and a supercapacitor in a single system to obtain simultaneously the ability to accumulate and supply both high energy and high power.

Indeed, the Inventors have surprisingly observed and unexpectedly found that a hybrid device comprising an electrochemical cell, for example, Lithium-Sulphur or Sodium-Sulphur or Metal-Oxygen, directly connected with a supercapacitor is capable to manage autonomously high energy and high power conditions since, based on energy needs, the current flows into the electrochemical cell or into the supercapacitor.

As aforesaid, the present invention exploits the disadvantages of Lithium-Sulphur batteries transforming them in advantages; in particular, the migration and solubility of polysulphides towards the cathode surface causes the cathode to have two faces and to be used as a single cathode both for the electrochemical cell and for the supercapacitor.

In the present description, the term “electrochemical cell” means a device capable of converting electrical energy into chemical energy or vice versa; in the present description, the term “battery” is used as a synonym of the term “electrochemical cell”.

In the present description, the term “supercapacitor” means a particular capacitor which has the characteristic of accumulating an exceptionally large amount of electric charge with respect to common capacitors.

In the present description, the term “anode” means the negative electrode of the battery and the place where the oxidation reactions occur during the discharge.

In the present description, the term “cathode” means the positive electrode of the battery and the place where the reduction reactions occur during the discharge.

In the present description, the term “electrolyte” means a substance which, in solution, is able to dissociate completely or partially into ions, the electrolyte can be liquid or solid and guarantees the transfer of ions between the two electrodes during the battery and the supercapacitor operation.

In the present description, the term “porous matrix” means a porous substance capable of accommodating the Sulphur in the case of a Lithium-Sulphur battery or of ensuring the electronic transfer from and to oxygen which passes into it in the case of Metal-Oxygen systems.

In the present description, the term “infusion” means the high-temperature process for the insertion of the molten Sulphur into the pores of the porous matrix.

In the present description, the term “active substance” means the material that oxidizes and reduces at the electrodes.

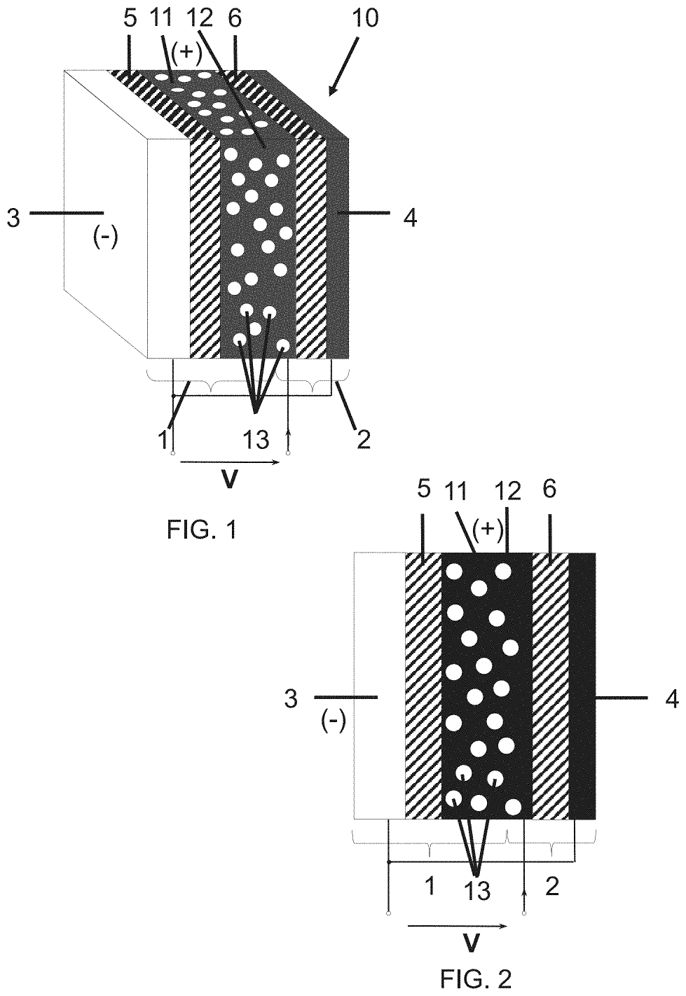

The electrochemical device 10 in the general embodiment according to the present invention is outlined in FIGS. 1 and 2; such electrochemical device 10 comprises an electrochemical cell 1 and a supercapacitor 2.

The electrochemical cell 1 comprises a first metal anode 3 facing towards a first electrolyte 5.

The supercapacitor 2 comprises a second anode 4 facing towards a second electrolyte 6; more particularly, the supercapacitor 2 consists of a first carbonaceous-based electrode, specifically the aforementioned anode 4, and of a second electrode consisting of the surface of a single cathode 11—which will be described hereafter—facing towards the electrolyte 6. The anode 4 is preferably composed of activated carbons with a high surface area which, like the surface of the single cathode 11 facing towards the electrolyte 6, are electrically polarized due to the potential difference applied to them; consequently, at the interface among the electrodes 11 and 4 and the electrolyte 6, a layer of ions is formed with a charge opposite to that of the electrode itself, called double electric layer.

The electrochemical device 10 also comprises a single cathode 11 shared by both the electrochemical cell 1 and the supercapacitor 2; such single cathode 11 comprises, in turn, a porous matrix 12 in which an active substance 13, belonging to the group of the Chalcogens, or group 16 of the Periodic Table of the Elements, is infused.

Preferably, the porous matrix 12 of the single cathode 11 is made of a conductive material, more preferably is made of a conductive material selected from porous carbon, Nickel (Ni) foam, carbon nanotubes (CNT) or ordered mesoporous carbons (OMC), even more preferably is made of porous carbon.

Preferably, the active substance 13 of the single cathode 11 is Sulphur (S) or Oxygen (O).

The electrochemical cell 1 and the supercapacitor 2 are arranged in series; in the general and preferred embodiment of the present invention, the series formed by the electrochemical cell 1 and the supercapacitor 2 has the following sequence:
the first anode 3 is contiguous to the first electrolyte 5,
the first electrolyte 5 is contiguous to the single cathode 11 on the side opposite to the first anode 3,
the single cathode 11 is contiguous to the second electrolyte 6 from the side opposite to the first electrolyte 5,
the second electrolyte 6 is contiguous to the second anode 4 from the side opposite to the single cathode 11, and
the first anode 3 and the second anode 4 are directly connected to each other, on the sides opposite to the first electrolyte 5 and to the second electrolyte 6, respectively.

The first anode 3 is made of a metallic material selected from i) the alkali metals, or metals of group 1, and ii) the alkaline-earth metals, or metals of group 2, of the Periodic Table of Elements.

Preferably, the first anode 3 is made of metallic Lithium (Li) or Sodium (Na) or metallic Zinc (Zn), preferably pure (i.e. having a purity higher than 99.9%); preferably, Lithium or Sodium are used in the case in which the cathodic active substance is Sulphur, whereas Lithium or Zinc are preferably used in the case in which the cathodic active substance is Oxygen.

The first electrolyte 5 may be liquid, polymeric or solid,
if liquid, it is imbibed on a separator having a cellulosic, polymeric or glass fibres base and is selected from i) organic liquids, ii) aprotic, protic or zwitterionic ionic liquids and iii) water-based solutions in the case in which the first anode 3 is an alkaline-earth metal and in which the cathodic active substance 13 is Oxygen (O);
if polymeric, it is a good ionic conductor, i.e. with a conductivity higher than 10⁻⁵ S/cm, and is selected from i) polymers based on methacrylates, poly(vinylidene-fluoride) (PVdF), poly(vinylidene-fluoride-co-hexafluoropropylene) (PVdF-HFP), polyethylene-oxide (PEO), polystyrene (PS), poly(ethylene-glycol) (PEG), poly(ethylene-glycol) diacrylate (PEGDA), poly(ethylene-glycol) diglycidyl ether (PEGDE), and polycarbonates in general, or any block polymer or three-dimensional structures (also interpenetrating networks) based on any polymer among those mentioned hereabove, and ii) polymeric/ceramic hybrids comprising powders based on Aluminum oxide (Al₂O₃), Titanium oxide (TiO₂), silicates or perovskites;
if solid, it has a ceramic or a vetrous base, and it is selected from borosilicates, silicates, aluminas and sulphides, for example.

Considering, by way of example and without limitation, that the first anode 3 is made of Lithium, the first electrolyte 5 is liquid and contains an organic solvent in which a salt containing Lithium ions is dissolved (for example, LiPF₆, LiBF₄, LiSbF₆, LiAsF₆, LiClO₄, LiNO₃, LiCF₃SO₃, LiTFSI, LiN(C₂F₅SO₂)₂, LiAl₄, LiAlCl₄ or a mixture thereof).

Considering, by way of example and without limitation, that the first anode 3 is made of Sodium, the first electrolyte 5 is liquid and contains an organic solvent in which a salt containing Sodium ions is dissolved (for example, NaCF₃SO₃).

Considering, by way of example and without limitation, that the single cathode comprises Oxygen, the first electrolyte 5 is liquid and contains an organic solvent in which a salt is dissolved (for example, LiPF₆, Li(CF₃SO₂)₂N(LiTFSI), LiCF₃SO₃₋, LiClO₄, KOH, ZnCl₂, Zn(OH)₂).

In particular, the first electrolyte 5 can be an ionic liquid composed of the following cations and anions:
the cations for the formation of the double electric layer can be: tetrabutylammonium, 1-ethyl 3-methylimidazolium, 1-butyl-3 methylimidazolium, 1-(3-cyanopropyl)-3-methylimidazolium, 1,2-dimethyl-3-propylimidazolium, 1,3-bis(3-cyanopropyl)imidazolium, 1,3-dietoxyimidazolium, 1-butyl-1-methylpiperidinium, 1-butyl-2,3-dimethylimidazolium, 1-butyl-4-methylpyridinium, 1-butylpyridinium, 1-decyl-3-methylimidazolium, 3-methyl-1-propylpyridinium or mixtures thereof;
the anions for the formation of the double electric layer can be: ethyl-sulphate, methyl-sulphate, thiocyanate, acetate, chloride, methane-sulphonate, tetra-chloro-aluminate, tetra-fluoro-borate, hexafluoro-phosphate, trifluoro-methane sulphonate, bis(pentafluoroethane-sulphonate)imide, trifluoro (trifluoromethyl)borate, bis(trifluoromethane-sulphonate)imide, tris(trifluoromethane-3-sulphone)methide, dicyanamide or mixtures thereof.

The second electrolyte 6 may be liquid or polymeric, preferably polymeric,
if liquid, it is imbibed on a separator having a cellulosic, a polymeric or glass fibres base and is selected from i) organic liquids (solutions of quaternary organic salts of conductive tetrafluoroborate ammonium or phosphonium, such as propylene carbonate, acetonitrile and mixtures thereof, ii) aprotic, protic or zwitterionic ionic liquids, preferably aprotic liquids, more or less diluted in an organic solvent.
if polymeric, it is a good ionic conductor, i.e. with a conductivity higher than 10⁻⁵ S/cm, and is selected from i) polymers based on methacrylates, poly(vinylidene-fluoride) (PVdF), poly(vinylidene-fluoride-co-hexafluoropropylene) (PVdF-HFP), polyethylene-oxide (PEO), polystyrene (PS), poly(ethylene-glycol) (PEG), poly(ethylene-glycol) diacrylate (PEGDA) or poly(ethylene-glycol) diglycidyl ether (PEGDE), ii) polycarbonates, iii) block polymers, iv) three-dimensional structures based on such polymers and v) polymeric/ceramic hybrids comprising powders based on Aluminum oxide (Al₂O₃), Titanium oxide (TiO₂), silicates or perovskites;
if solid, it has a ceramic or a vetrous base and is preferably selected from borosilicates, silicates, aluminas or sulphides.

The second anode 4 is a porous layer having a high surface area and is made of a carbonaceous material or other well conductive materials such as graphite, carbon nanotubes (CNT) or ordered mesoporous carbons (OMC) or active carbons (AC), for example.

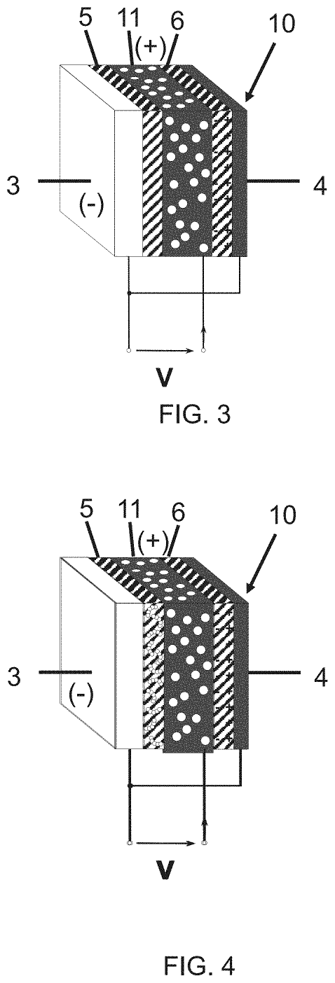

In particular and with reference to FIG. 3, which illustrates the first operating step of the electrochemical device 10, it can be seen that when the current is high, it passes through the supercapacitor that polarizes, while it does not pass through the Lithium-Sulphur cell as at high currents the operating potential of the electrochemical cell practically drops to zero; this first operating step occurs under high current conditions, that is with current values C in the range of 2<C<30; in this first operating step only the supercapacitor works, which is in charge, and therefore the device accumulates high-power energy by means of coulombic processes.

In particular and with reference to FIG. 4, which illustrates the second operating step of the electrochemical device 10, it can be seen that at low currents the supercapacitor charges very quickly, but also that the electrochemical cell can be charged and the formation of polysulphides in solution is observed; this second operating step takes place under low current conditions, i.e. with current values C in the range of 0.001<C<2; in this second operating step both the electrochemical cell and the supercapacitor work and, therefore, the device is charged by means of both faradic and coulombic processes.

The voltage difference V between the two anodes 3 (for example, in Lithium) and 4 (for example, in Carbon) is very low (about 0.1 V) and for this reason, they can be connected together.

It is known that the supercapacitor 2 can operate at very high currents C (C>1,000) if the current C applied to the device 10 is very high, the current C can only flow through the supercapacitor 2, since at the high current C the voltage V of the electrochemical cell 1, for example a Lithium-Sulphur cell, is close to 0 V.

When the current C applied to the device 10 is low, the supercapacitor 2 charges in a few seconds and then the electrochemical cell 1 starts charging, accumulating a very high quantity of energy; the opposite occurs during the discharge: when low currents C are required, the electrochemical cell 1 works, for example a Lithium-Sulphur cell, but when high power is required, the device 10 continues to operate thanks to the presence of the supercapacitor.

It is desired to reiterate that the operation described above cannot occur in traditional Lithium-ion batteries alone, since the reactions occurring in the electrochemical cell must be separate from those occurring in the supercapacitor.

The electrochemical device 10 according to the present invention is able to accumulate and to deliver simultaneously high energy levels, i.e. energy levels higher than 500 Wh/kg, and high power levels, i.e. power levels higher than 1,000 W/kg, making the current flow autonomously into the electrochemical cell 1 or into the supercapacitor 2 depending on energy needs, thus realizing the automatic switching of the electrochemical device 10.

Returning to the single cathode 11, it is designed to allow the infusion of the active substance 13, preferably Sulphur, into the porous matrix 12, preferably made of porous carbon, and also to allow the oxidation/reduction reactions of the active substance 13.

The active substance 13 is infused in the single cathode 11 in an amount greater than 10% wt.

The active substance 13 in the single cathode 11 near the first electrolyte 5 is present in a concentration at least 5% higher than the concentration of the active substance 13 near the first anode 3, as explained hereinbelow.

By way of example and without limitation, considering that the active substance 13 is Sulphur, such Sulphur is infused into the pores of the porous matrix 12 before the assembly of the electrochemical device 10; the infusion process is carried out in a traditional way, for example by impregnating the porous matrix 12 with the Sulphur at 120° C., temperature at which the Sulphur liquifies.

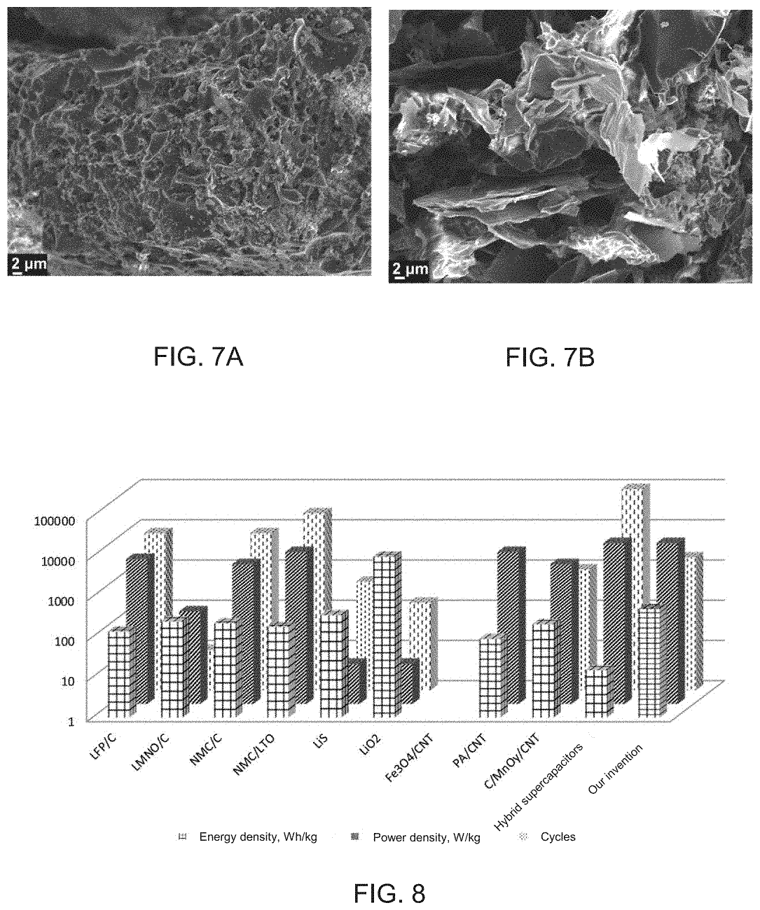

FIGS. 7A and 7B are SEM (Scanning Electron Microscope) images showing, respectively, the porous matrix 12 of the single cathode 11 of the electrochemical device 10 without Sulphur and with infused Sulphur; as it can be seen, the distribution of Sulphur through graphite is very homogeneous.

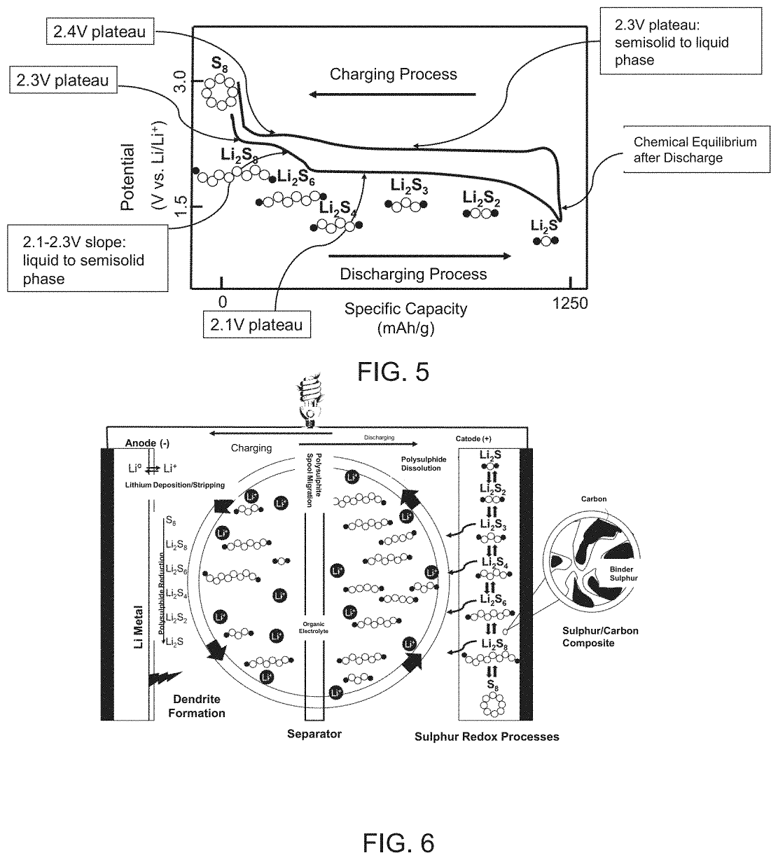

Sulphur, during the operation of the electrochemical device 10, moves towards the surface of the electrode 11 going into solution as polysulphides; at the end of the reduction process, it re-precipitates as solid Lithium sulphide (Li₂S), according to the reaction diagram shown in FIG. 5. With reference to FIGS. 5 and 6 and, by way of example and without limitation, considering that the electrochemical cell 1 is a Lithium-Sulphur cell, it comprises the first Lithium metal anode, an organic electrolyte and the carbon composite cathode (porous matrix) and the Sulphur infused in it. The overall Lithium-Sulphur (Li—S) redox reaction can be represented as follows:

16Li+S₈→8Li₂S

During the discharge, the Sulphur is reduced by opening its eight Sulphur-atom ring to form polysulphide ions (LiₓS, with x=2-8), soluble in solution.

At the anode, the metallic Lithium oxidizes into Li⁺ ions, which bind to the negative ions formed at the cathode.

At the end of the discharge, Lithium sulphide (Li₂S) is formed, whose volume is greater than that the elemental Sulphur initially had.

FIG. 5 summarizes the above reaction diagram and shows the curve of the charge and discharge processes; FIG. 6 schematizes, instead, the operating diagram of a Lithium-Sulphur electrochemical cell.

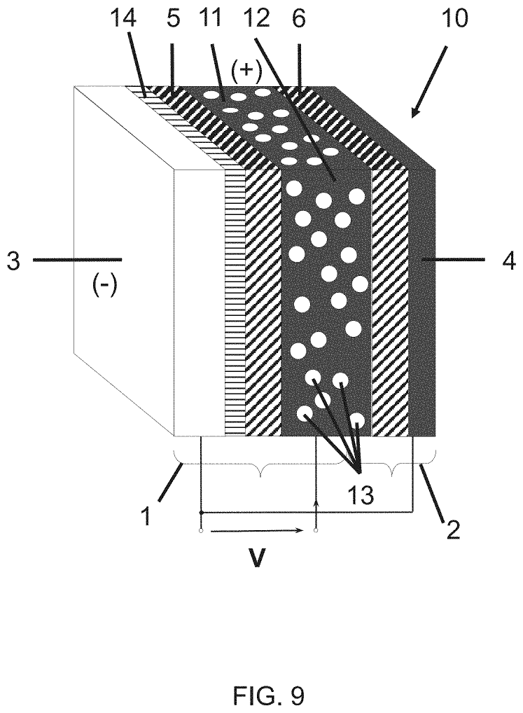

With reference to FIG. 9, the electrochemical device 10 can further comprise a protective membrane 20 interposed between the first anode 3 and the first electrolyte 5.

The protective membrane 20 can be of polymeric, ceramic, hybrid polymeric/ceramic nature or it can be a solid/electrolyte interface (SEI).

The specific advantage of this first alternative embodiment of the electrochemical device 10 according to the present invention lies mainly in the fact of giving the device 10 greater safety, since the presence of the protective membrane 20 makes the formation of metal dendrites more difficult and protects the Lithium from the direct discharge of polysulphides on its surface.

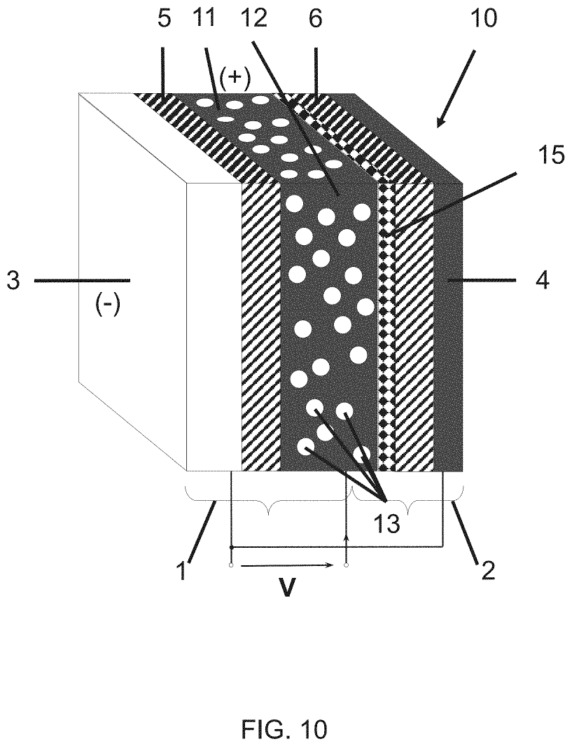

With reference to FIG. 10, the electrochemical device 10 can further comprise an oxide-based material 21 arranged on the surface of the single cathode 11 from the side contiguous to the second electrolyte 6.

The oxide-based material 21 can be TiOₓ, MnOₓ and the like; it acts as a cathode for the supercapacitor and as an intermediate layer for the electrochemical cell.

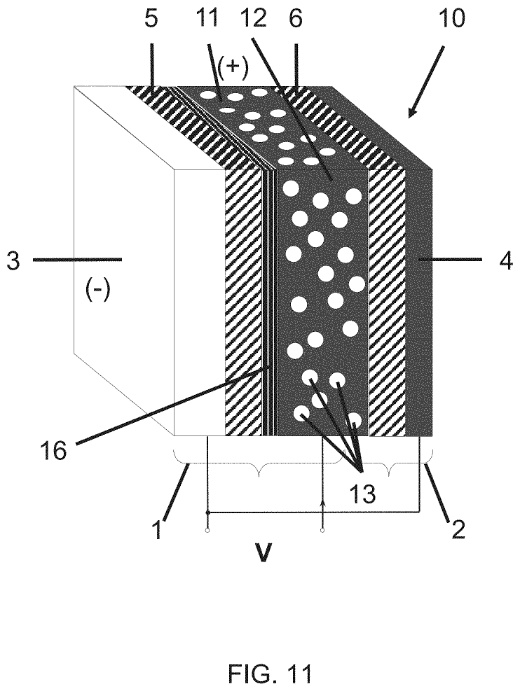

The specific advantage of this second alternative embodiment of the electrochemical device 10 according to the present invention lies mainly in the fact of increasing the power of the device 10. With reference to FIG. 11, the electrochemical device 10 can further comprise an additional layer 22, preferably of porous carbon having a high surface area, arranged on the surface of the single cathode 11 from the side opposite to the second electrolyte 6.

The additional layer 22 can also be an oxide, for example MnO₂, which makes the supercapacitor asymmetrical.

The specific advantage of this third alternative embodiment of the electrochemical device 10 according to the present invention lies mainly in the fact of reducing the migration of polysulphides towards the first anode 3 and of improving the performance of the electrochemical cell.

The electrochemical device according to the present invention is described below in greater detail with reference to the following Examples, which have been developed on the basis of experimental data and which are intended as illustrative, but not limiting, of the present invention.

### Example 1

An electrochemical device 10, as that illustrated in FIG. 1, is realized. The first anode 3 is pure metallic lithium; the first electrolyte 5 is dimethoxyethane 1:1 dioxylane with Lithium bis(trifluoromethane)sulphonimide salt, the cathode 11 is a mixture of carbon and sulphur; the second electrolyte 6 is 1-butyl-3-methylimidazolium tetrafluoroborate 1M; the second anode 4 is activated carbon.

The galvanostatic measurement of Example 1 is a discharge and charge curve at constant current and the potential is measured, as shown in FIG. 12.

According to Example 1, the galvanostatic measurement is carried out at low currents C/5, that is at the current required to fully charge or discharge the device in 5 hours.

It can be observed the typical trend of the Lithium-Sulphur cell for the two complete cycles made, that is similar to the typical trend described previously in FIG. 5.

### Example 2

An electrochemical device 10, as that illustrated in FIG. 1, is realized. The first anode 3 is pure metallic lithium, the first electrolyte 5 is dimethoxyethane 1:1 dioxylane with Lithium bis(trifluoromethane)sulphonimide salt; the cathode 11 is a mixture of carbon and sulphur; the second electrolyte 6 is 1-butyl-3-methylimidazolium tetrafluoroborate 1M; the second anode 4 is activated carbon.

The galvanostatic measurement of Example 2 is a discharge and charge curve at constant current and the potential is measured, as shown in FIG. 13.

According to Example 2, the galvanostatic measurement is carried out at high currents 10 C, that is at the current required to fully charge or discharge the device in 6 minutes.

It can be noted that, despite the very high currents for a Lithium-Sulphur cell, the electrochemical device according to the present invention continues to operate correctly as it is protected by the capacitor, which absorbs the high current.

### Example 3

An electrochemical device 10, as that illustrated in FIG. 1, is realized. The first anode 3 is pure metallic lithium, the first electrolyte 5 is dimethoxyethane 1:1 dioxylane with Lithium bis(trifluoromethane)sulphonimide salt; the cathode 11 is a mixture of carbon and sulphur; the second electrolyte 6 is 1-butyl-3-methylimidazolium tetrafluoroborate 1M; the second anode 4 is activated carbon.

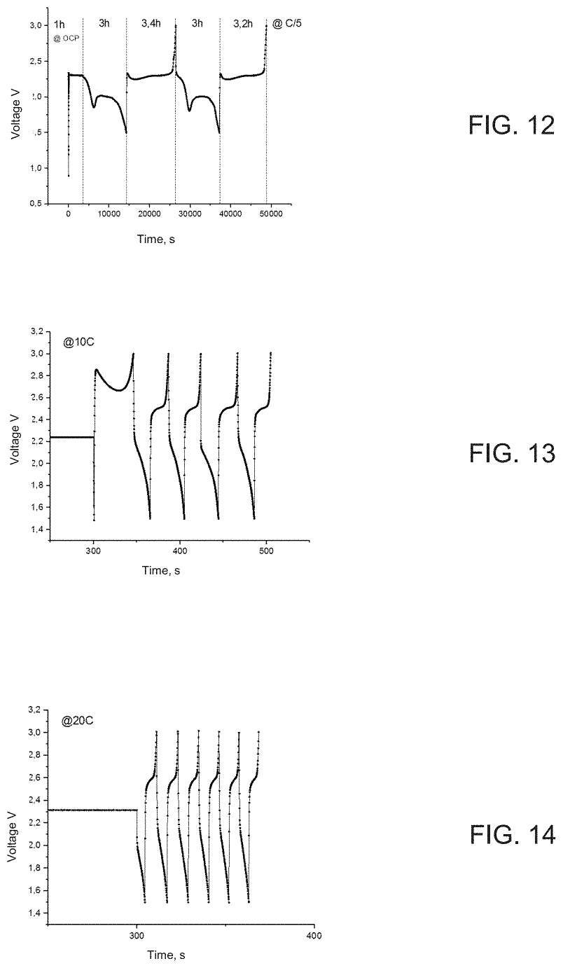

The galvanostatic measurement of Example 3 is a discharge and charge curve at constant current and the potential is measured, as shown in FIG. 14.

According to Example 3, the galvanostatic measurement is carried out at very high currents 20 C, that is at the current required to fully charge or discharge the device in three minutes.

It can be noted that, also with this currents, that cannot be born by a Lithium-Sulphur cell alone, the electrochemical device according to the present invention continues to operate correctly as it is protected by the capacitor, which absorbs the high current.

The electrochemical device according to the present invention is compared with known solutions in terms of energy density, power density and operating cycles, which have been determined as described below.

### Energy Density Measurement

The energy density is obtained from the measured potential and current values, as well as from the measured capacity (calculated as a product of the current intensity by the time), all compared to the weight or volume of the device.

In particular, the following instruments are used for the measurement: electrochemical galvanostat and electrochemical potentiostat.

Example 1 is used for the energy density measurement. From the current data set during the discharge, the determined voltage, the time required for the complete discharge and the mass in kg of sulphur in the cathode 11, it is possible to calculate the energy density, given by the product of the current in Amperes, the time in hours and the voltage in Volts, and divided by the kgs of active matter (sulphur in the cathode 11). From the data of Example 1 carried out at C/5, a test performed to observe the behaviour of the device at low current and therefore as a high energy accumulator, an energy density of 2,195 Wh/kg is determined.

### Measurement of Power Density

The power density is obtained from the measured potential and current values, as well as from the measured capacity (calculated as a product of the current intensity by the time).

In particular, the following instruments are used for the measurement: electrochemical galvanostat and electrochemical potentiostat.

Example 2 is used for power density measurement. From the current data set during the discharge, the determined voltage, and the mass in kg of sulphur in the cathode 11, it is possible to calculate the power density, given by the product of the current in Amperes and the voltage in Volts, and divided by the kgs of active matter (sulphur in the cathode 11). From the data of Example 2 carried out at 10 C, a test performed to observe the behaviour of the high current device and therefore as a high power accumulator, a power density of 6,700 W/kg is determined.

The same measurement carried out on the data of Example 3 carried out at 20 C, a test performed to observe the behaviour of the device at very high current and therefore as a high power accumulator, an power density of 12,000 W/kg is determined.

### Measurement of Operating Cycles

The number of operating cycles is determined by taking the cell to its end of life.

In particular, the following instruments are used for the measurement: electrochemical galvanostat and electrochemical potentiostat.

In laboratory tests, after about ten cycles, no decreases in the performance of the device according to the present invention were observed.

### Determination of the Cost

The cost is estimated on the basis of some methods known in the field, such as the energy density or the power density compared to the manufacturing cost of the device, for example.

The cost takes into account the low costs of materials that can be used at industrial level.

The results of the comparison between the electrochemical device according to the present invention and the known solutions are summarized in the Table below.

TABLE

| | | | Power | | |
|---|---|---|---|---|---|
| | Chemical | Energy Density | Density | Cycles | Cost |
| | Composition | [Wh/kg] | [W/kg] | [Number] | [€/kWh] |
| Lithium-Ion | Lithium Iron | 137 | 4,000 | 8,000 | 350-2,000 |
| Technology | Phosphate | | | | |
| | (LPF)/Graphite (C) | | | | |
| | Lithium Manganese | 243 | 200 | <100 | Not commercially |
| | Oxide | | | | available |
| | (LMNO)/Graphite (C) | | | | |
| | Nickel Manganese | 220 | 1,000 | 8,000 | >400 |
| | Cobalt Oxide | | | | |
| | (NMC)/Graphite (C) | | | | |
| | Nickel Manganese | 180 | 6,000 | 25,000 | >2,000 |
| | Cobalt Oxide | | | | |
| | (NMC)/Lithium | | | | |
| | Titanate (LTO) | | | | |
| Post | Lithium-Sulphur | 350 | N.D. | 500 | >200 |
| Lithium-Ion | (LiS) | | (in high energy | | |
| Technology | | | systems, power | | |
| | | | cannot be | | |
| | | | determined) | | |
| | Lithium-Oxygen | 10,000 | N.D. | 150 | Not commercially |
| | (LiO₂) | (Theoretical Value) | (in high energy | | available |
| | | | systems, power | | |
| | | | cannot be | | |
| | | | determined) | | |
| Combined | Iron Oxide | 247 mAh/g | 0.4 W/cm³ | | Not commercially |
| Hybrid Systems | (Fe₃O₄)/Carbon | | | | available |
| | Nanotabes (CNT) | | | | |
| | Polianiline Doped | 90 | 6,000 | | Not commercially |
| | Nanofibres | | | | available |
| | (PA)/Carbon | | | | |
| | Nanotubes (CNT) | | | | |
| | Carbon | 208.6 | 3,000 | 1,000 | Not commercially |
| | (C)/Manganese Oxide | | | | available |
| | (MnOy)/Carbon | | | | |
| | Nanotubes (CNT) | | | | |
| Hybrid | Carbons and | 1.5-15 | 2,000-10,000 | Up To 10⁵ | >500 |
| Supercapacitors | Nanostuctured | | | | |
| | Faradic Materials | | | | |
| Present | LiS/Supercap | 500 | 10,000 | 2,000 | 100 |
| invention | | | | | |

The above Table shows the results of the comparison between the electrochemical device according to the present invention and commercially available systems (Lithium-ion, specifically Lithium-Sulphur, described in the prior art documents such as Aurbach et al., Materials Today, 17 (3), 110-121, 2014 and Hannan el al., Renewable and Sustainable Energy Reviews, 69, 771-789, 2017), systems under study not commercially available (Post Lithium-Ion, described in prior art documents such as Hagen et al., Journal of Power Sources, 264, 30-34, 2014 and Liang et al., Adv. Energy Mater., 6, 1501636, 2016) and hybrid systems under study that are not commercially available (described in prior art documents such as Zhou et al., Journal of the Electrochemical Society, 163 (13) A2618-A2622, 2016 and Wei et al., Nano Energy 34 205-214, 2017; Li et. al. Advanced Functional Materials, 25 (33), 5384-5394, 2015).

The data shown in the above Table are also shown in FIG. 8, which is a bar graph showing the performance of the electrochemical device according to the present invention compared to the performances of known solutions and which illustrates, in particular, how the present invention is generally positioned at the highest ranks for the different parameters mentioned.

It is apparent that the electrochemical device according to the present invention is able to reach very high energy and power values by combining an electrochemical cell and a supercapacitor; such result is achieved by exploiting the problems associated with the Lithium-Sulphur battery technology and turning them into advantages.

In fact, during the discharge step, the Sulphur is reduced by opening the eight Sulphur-atoms ring and forming Lithium polysulphides, which are soluble in the electrolyte 5.

At the end of the reduction reaction, Lithium Sulphide (Li₂S) is formed on the surface of the cathode 11.

The dissolution and re-precipitation cycles cause the reactions to take place only on the surface of the cathode 11 and the Sulphur to move gradually towards the surface of the cathode 11 itself; the fact that the polysulphides go into solution does not guarantee their re-precipitation on the cathode, but it could happen that they directly deposit on the metallic anode 3, an adverse event for Lithium-Sulphur batteries.

Instead, in the electrochemical device according to the present invention, the fact that the Sulphur can move towards the surface causes one side of the single cathode, the one facing the electrochemical cell, to be rich in Sulphur (at least 5% more), while the other side of the cathode, the one facing the supercapacitor, is substantially made up of carbon.

Thus, during cycling, two directly coupled systems are realized.

Furthermore, an independent aspect that can be used autonomously with respect to the other aspects of the invention represents an electric vehicle comprising at least one electrochemical device 10 as described above.

In the long term, the aforementioned application provides for the realization of storage systems for large amounts of energy that can be made available all together (power); braking energy will also be easier to recover.

According to the predictions made by the Applicant based on experimental laboratory data, thanks to the rapid recharge allowed by the electrochemical device according to the present invention, a very efficient energy recovery from deceleration and braking of the electric motor will be possible, thus allowing a more rapid transition from cars with combustion engines to electric vehicles.

Moreover, the use of the electrochemical device according to the present invention will make it possible the operation in association with an electric car for over 700 km for each charge, compared to the actual 150-200 km of current technologies.

Finally, by comparing the current Lithium-ion systems, specifically Lithium-Sulphur, with the energy densities of the electrochemical device according to the present invention, each cycle of the electrochemical device according to the present invention corresponds to at least four cycles of the Lithium-ion systems, specifically Lithium-Sulphur ones, under the same operating conditions; consequently, the electrochemical device according to the present invention can operate for at least fifteen years without being replaced, an aspect that will surely interest car manufacturers.

Furthermore, an independent aspect that can be used autonomously with respect to the other aspects of the invention represents a renewable energy storage system comprising at least one electrochemical device 10 as described above.

The aforementioned application provides for the realization of accumulators capable of managing also variable power peaks, typical of stationary storage systems, such as renewable energies.

According to the predictions made by the Applicant based on experimental laboratory data, the future use of the electrochemical device according to the present invention will allow reducing the variability of the energy flow of renewable energy plants.

As it can be deduced from the foregoing, the innovative technical solution described herein has the following advantageous features:
obtain an energy density of at least 500 Wh/kg;
obtain a power density of at least 10,000 W/kg;
ensure at least 2,000 cycles;
have a high versatility of design and use, according to specific needs;

From the description above, therefore, it is apparent how the electrochemical device according to the present invention allows achieving the intended objects.

Therefore, it is apparent to a person skilled in the art that it is possible to make modifications and further variants to the solution described with reference to the accompanying figures, without departing from the teaching of the present invention and from the scope of protection, as defined by the appended claims.

What is claimed is:

1. An electrochemical device, comprising an electrochemical cell and a supercapacitor, wherein
the electrochemical cell comprises a first anode and a first electrolyte;
the supercapacitor comprises a second anode and a second electrolyte;
the electrochemical cell and the supercapacitor are arranged in series, wherein
a single cathode is shared by both the electrochemical cell and the supercapacitor; and
the single cathode comprises a porous matrix, wherein an active substance belonging to a group of the Chalcogens, or group 16, of the Periodic Table of the Elements is infused inside the porous matrix.

2. The electrochemical device according to claim 1, wherein the series formed by the electrochemical cell and the supercapacitor comprises the following sequence:
the first anode is contiguous to the first electrolyte,
the first electrolyte is contiguous to the single cathode on a side opposite to the first anode,
the single cathode is contiguous to the second electrolyte from a side opposite to the first electrolyte,
the second electrolyte is contiguous to the second anode from a side opposite to the single cathode, and
the first anode and the second anode are directly connected to each other, on the side opposite to the first electrolyte and on a side opposite to the second electrolyte respectively.

3. The electrochemical device according to claim 2, wherein
the first anode is made of a metallic material selected from alkali metals, or metals of group 1, and alkaline-earth metals, or metals of group 2, of the Periodic Table of Elements, wherein the first anode is made of Lithium (Li) or Sodium (Na) or Zinc (Zn);
the first electrolyte is liquid, polymeric or solid,
if the first electrolyte is liquid, the first electrolyte imbibed on a separator comprises a cellulosic base, a polymeric base or glass fibres base and the first electrolyte is selected from organic liquids and aprotic, protic or zwitterionic ionic liquids;
if the first electrolyte is polymeric, the first electrolyte is an ionic conductor with a conductivity higher than 10⁻⁵ S/cm, and the first electrolyte is selected from polymers based on methacrylates, poly(vinylidene-fluoride) (PVdF) or polyethylene-oxide (PEO) and polymer/ceramic hybrids comprising powders based on Aluminum oxide (Al₂O₃), Titanium oxide (TiO₂), silicates or perovskites;
if the first electrolyte is solid, the first electrolyte comprises ceramic base or a vetrous base, wherein the first electrolyte is selected from borosilicates, silicates, aluminas or sulphides;
the porous matrix of the single cathode is made of a conductive material, wherein the conductive material selected from porous carbon, Nickel (Ni) foam, carbon nanotubes (CNT) or ordered mesoporous carbons (OMC);
the active substance of the single cathode is Sulphur (S) or Oxygen (O);
the second electrolyte is liquid, polymeric, or solid
if the second electrolyte is liquid, the second electrolyte imbibed on the separator comprises the cellulosic base, the polymeric base or the glass fibres base and the second electrolyte is selected from organic solvents comprising a salt with Lithium (Li) ions or a salt with Sodium (Na) ions, ionic liquids and water-based solutions, wherein the second electrolyte is the water-based solutions when the first anode is an alkaline-earth metal and the active substance is the Oxygen (O);
if the second electrolyte is polymeric, the second electrolyte is the ionic conductor with the conductivity higher than 10⁻⁵ S/cm, and the second electrolyte is selected from the polymers based on the methacrylates, the poly(vinylidene-fluoride) (PVdF), poly(vinylidene-fluoride-co-hexafluoropropylene) (PVdF-HFP), the polyethylene-oxide (PEO), polystyrene (PS), poly(ethylene-glycol) (PEG), poly(ethylene-glycol) diacrylate (PEGDA) or poly(ethylene-glycol) diglycidyl ether (PEGDE), polycarbonates, block polymers, three-dimensional structures based on the polymers and the polymeric/ceramic hybrids comprising the powders based on the Aluminum oxide (Al₂O₃), the Titanium oxide (TiO₂), the silicates or the perovskites;
if the second electrolyte is solid, the second electrolyte comprises the ceramic base or the vetrous base, wherein the second electrolyte is selected from the borosilicates, the silicates, the aluminas or the sulphides;
the second anode is made of carbonaceous material.

4. The electrochemical device according to claim 1, wherein the active substance is infused in the single cathode in an amount greater than 10% by weight and wherein the active substance in the single cathode facing the first electrolyte is present in a concentration higher than of at least 5% with respect to a concentration of the active substance facing the first anode.

5. The electrochemical device according to claim 1, further comprising a protective membrane interposed between the first anode and the first electrolyte.

6. The electrochemical device according to claim 1, further comprising an oxide-based material placed on a surface of the single cathode from a side contiguous to the second electrolyte.

7. The electrochemical device according to claim 1, further comprising an additional layer, wherein the additional layer is made of porous carbon or an oxide, wherein the additional layer is placed on a surface of the single cathode on a side opposite to the second electrolyte.

8. The electrochemical device according to claim 1, wherein the electrochemical device is configured to accumulate and deliver enemy levels with the energy levels higher than 500 Wh/kg at a same time, and power levels with the power levels higher than 1,000 W/kg, making a current independently flow into the electrochemical cell or into the supercapacitor depending on energy needs, and realizing an automatic switching of the electrochemical device.

9. An electric vehicle comprising at least the electrochemical device according to claim 1.

10. A renewable energy storage system comprising at least the electrochemical device according to claim 1.
